(19) United States
(12) Patent Application Publication
(10) Pub. No.: US 2016/0197755 A1
(43) Pub. Date: Jul. 7, 2016

(54) Deferral Information in Postambles and Midambles

(71) Applicant: QUALCOMM Incorporated, San Diego, CA (US)

(72) Inventors: Gwendolyn Denise Barriac, Encinitas, CA (US); George Cherian, San Diego, CA (US); Simone Merlin, San Diego, CA (US); Alfred Asterjadhi, San Diego, CA (US); Yan Zhou, San Diego, CA (US); Qingjiang Tian, San Diego, CA (US); Gang Ding, San Diego, CA (US); Bin Tian, San Diego, CA (US)

(21) Appl. No.: 14/989,576

(22) Filed: Jan. 6, 2016

Related U.S. Application Data
(60) Provisional application No. 62/100,866, filed on Jan. 7, 2015.

(51) Int. Cl. H04L 27/26; H04L 5/00; H04W 48/02; H04W 56/00

(52) U.S. Cl. CPC H04L 27/2613; H04W 56/0015; H04L 5/0048; H04W 48/02

(57) ABSTRACT

Certain aspects of the present disclosure relate to including deferral information in postambles and midambles. An apparatus for wireless communications may generally include a processing system configured to generate a first frame having at least one of a midamble or a postamble that provides an indication of a request for a device to defer transmitting for a duration and an interface configured to output the first frame for transmission. Another apparatus for wireless communications may generally include a processing system configured to generate a frame having at least one of a midamble or a postamble designed to allow a device, after exiting a low-power state, to perform synchronization to the frame and an interface for outputting the frame for transmission. Including midambles and postambles in a frame allow for more reliable responses and may reduce throughput losses and interference.

### CROSS-REFERENCE TO RELATED APPLICATIONS

This application claims benefit of U.S. Provisional Application Ser. No. 62/100,866, entitled “DEFERRAL INFORMATION IN POSTAMBLES AND MIDAMBLES,” filed on Jan. 7, 2015, which is hereby expressly incorporated by reference herein.

### BACKGROUND

1. Field of the Disclosure

Certain aspects of the present disclosure generally relate to wireless communications and, more particularly, to including deferral and/or synchronization information in postambles and midambles.

2. Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure generally relate to including deferral information in postambles and midambles.

Certain aspects of the present disclosure provide an apparatus for wireless communications. The apparatus generally includes a processing system configured to generate a first frame having at least one of a midamble or a postamble that provides an indication of a request for a device to defer transmitting for a duration and an interface configured to output the first frame for transmission.

Certain aspects of the present disclosure provide an apparatus for wireless communications. The apparatus generally includes an interface configured to obtain a frame having at least one of a midamble or a postamble that provides an indication of a request for a device to defer transmitting on a medium for a duration and a processing system configured to defer transmitting on the medium based on the duration.

Certain aspects of the present disclosure provide an apparatus for wireless communications. The apparatus generally includes an interface configured to obtain a frame having at least one of a midamble or a postamble and a processing system configured to exit a low-power state and perform synchronization, after exiting the low-power state, based on the at least one of a midamble or a postamble.

Certain aspects of the present disclosure provide an apparatus for wireless communications. The apparatus generally includes a processing system configured to generate a frame having at least one of a midamble or a postamble designed to allow a device, after exiting a low-power state, to perform synchronization to the frame and an interface for outputting the frame for transmission.

Certain aspects of the present disclosure provide a method for wireless communications. The method generally includes generating a first frame having at least one of a midamble or a postamble that provides an indication of a request for a device to defer transmitting for a duration and outputting the first frame for transmission.

Certain aspects of the present disclosure provide a method for wireless communications. The method generally includes obtaining a frame having at least one of a midamble or a postamble that provides an indication of a request for a device to defer transmitting on a medium for a duration and deferring transmitting on the medium based on the duration.

Certain aspects of the present disclosure provide a method for wireless communications. The method generally includes obtaining a frame having at least one of a midamble or a postamble, exiting a low-power state, and performing synchronization, after exiting the low-power state, based on the at least one of a midamble or a postamble.

Certain aspects of the present disclosure provide a method for wireless communications. The method generally includes generating a frame having at least one of a midamble or a postamble designed to allow a device, after exiting a low-power state. to perform synchronization to the frame and outputting the frame for transmission.

Certain aspects of the present disclosure provide an apparatus for wireless communications. The apparatus generally includes means for generating a first frame having at least one of a midamble or a postamble that provides an indication of a request for a device to defer transmitting for a duration and means for outputting the first frame for transmission.

Certain aspects of the present disclosure provide an apparatus for wireless communications. The apparatus generally includes means for obtaining a frame having at least one of a midamble or a postamble that provides an indication of a request for a device to defer transmitting on a medium for a duration and means for deferring transmitting on the medium based on the duration.

Certain aspects of the present disclosure provide an apparatus for wireless communications. The apparatus generally includes means for obtaining a frame having at least one of a midamble or a postamble, means for exiting a low-power state, and means for performing synchronization, after exiting the low-power state, based on the at least one of a midamble or a postamble.

Certain aspects of the present disclosure provide an apparatus for wireless communications. The apparatus generally includes means for generating a frame having at least one of a midamble or a postamble designed to allow a device, after exiting a low-power state to perform synchronization to the frame and means for outputting the frame for transmission.

Certain aspects of the present disclosure provide a computer readable medium having instructions stored thereon for generating a first frame having at least one of a midamble or a postamble that provides an indication of a request for a device to defer transmitting for a duration and outputting the first frame for transmission.

Certain aspects of the present disclosure provide a computer readable medium having instructions stored thereon for obtaining a frame having at least one of a midamble or a postamble that provides an indication of a request for a device to defer transmitting on a medium for a duration and deferring transmitting on the medium based on the duration.

Certain aspects of the present disclosure provide a computer readable medium having instructions stored thereon for obtaining a frame having at least one of a midamble or a postamble, exiting a low-power state, and performing synchronization, after exiting the low-power state, based on the at least one of a midamble or a postamble.

Certain aspects of the present disclosure provide a computer readable medium having instructions stored thereon for generating a frame having at least one of a midamble or a postamble designed to allow a device, after exiting a low-power state, to perform synchronization to the frame and outputting the frame for transmission.

Certain aspects of the present disclosure provide an access point (AP). The AP generally includes at least one antenna, a processing system configured to generate a first frame having at least one of a midamble or a postamble that provides an indication of a request for a device to defer transmitting for a duration, and a transmitter configured to transmit the first frame via the at least one antenna.

Certain aspects of the present disclosure provide a station (STA). The STA generally includes at least one antenna, a receiver configured to receive, via the at least one antenna, a frame having at least one of a midamble or a postamble that provides an indication of a request for a device to defer transmitting on a medium for a duration, and a processing system configured to defer transmitting on the medium based on the duration.

Certain aspects of the present disclosure provide a STA. The STA generally includes at least one antenna, a receiver configured to receive, via the at least one antenna, a frame having at least one of a midamble or a postamble, and a processing system configured to perform synchronization, after exiting a low-power state, based on the at least one of a midamble or a postamble.

Certain aspects of the present disclosure provide an AP. The AP generally includes at least one antenna, processing system configured to generate a frame having at least one of a midamble or a postamble designed to allow a device, after exiting a low-power state, to perform synchronization to the frame, and a transmitter configured to transmit the frame via the at least one antenna.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an example time sequence of a device transmitting on top of a response from another device.

FIG. 5 is a flow diagram of example operations for wireless communications, in accordance with certain aspects of the present disclosure.

FIG. 5A illustrates example means capable of performing the operations shown in FIG. 5.

FIG. 6 is an example time sequence illustrating a postamble transmitted to protect a response, in accordance with certain aspects of the present disclosure.

FIG. 7 is a flow diagram of example operations for wireless communications, in accordance with certain aspects of the present disclosure.

FIG. 7A illustrates example means capable of performing the operations shown in FIG. 7.

FIG. 8 is a flow diagram of example operations for wireless communications, in accordance with certain aspects of the present disclosure.

FIG. 8A illustrates example means capable of performing the operations shown in FIG. 8.

FIG. 9 is a flow diagram of example operations for wireless communications, in accordance with certain aspects of the present disclosure.

FIG. 9A illustrates example means capable of performing the operations shown in FIG. 9.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to including deferral information in postambles and midambles. As will be described in more detail herein, an access point (AP) may send a frame having a midamble and/or a postamble which detecting devices may use to determine how to defer so that a protected response may sent by a station (STA) and/or may be used for synchronizing, for example so that a device may wake up and synchronize to the medium to send an acknowledgment.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

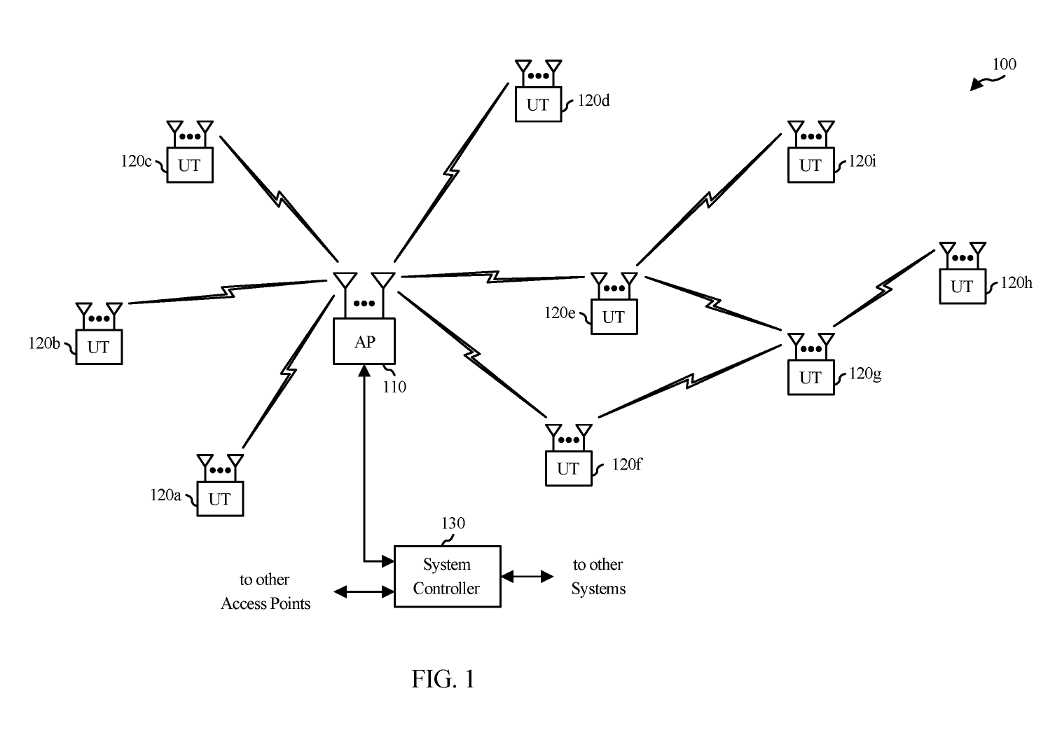

FIG. 1 illustrates a system 100 in which aspects of the disclosure may be performed. For example, the access point 110 may send user terminals 120 a frame having a midamble or postamble that provides an indication of request for a detecting device to defer transmitting for a duration. A neighbor access point 110 may detect the midamble or postamble and defer transmission for the duration indicated in the frame. User terminals 120 may then send protected acknowledgments (ACKs) and/or synchronize to the midamble and/or the postamble.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

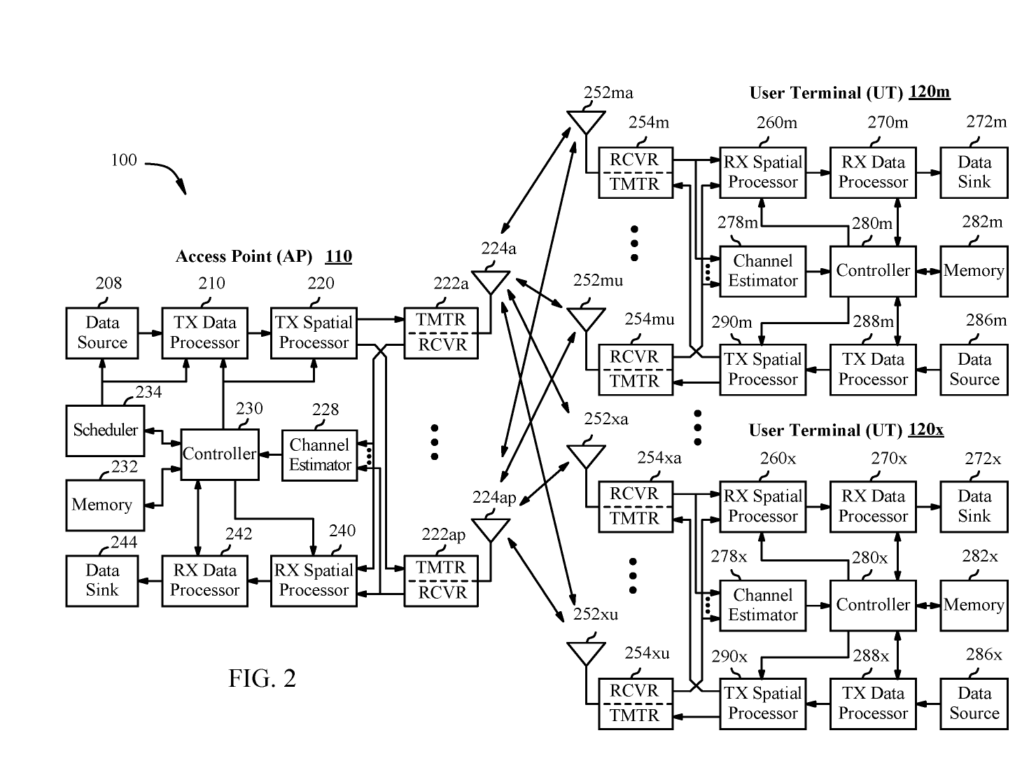

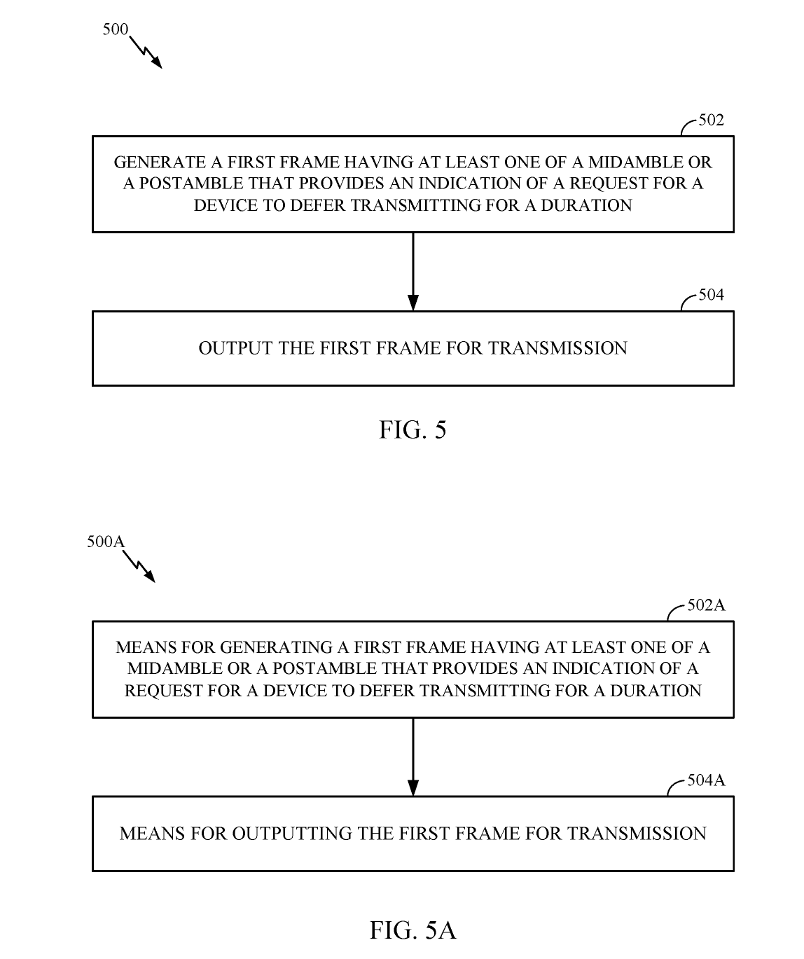

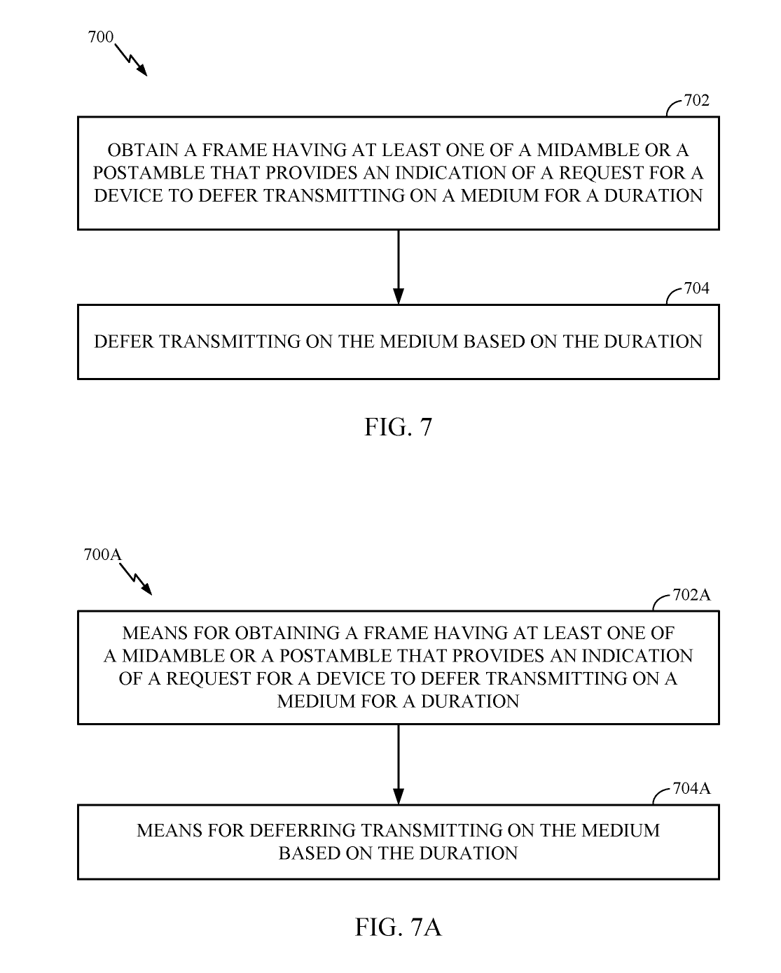

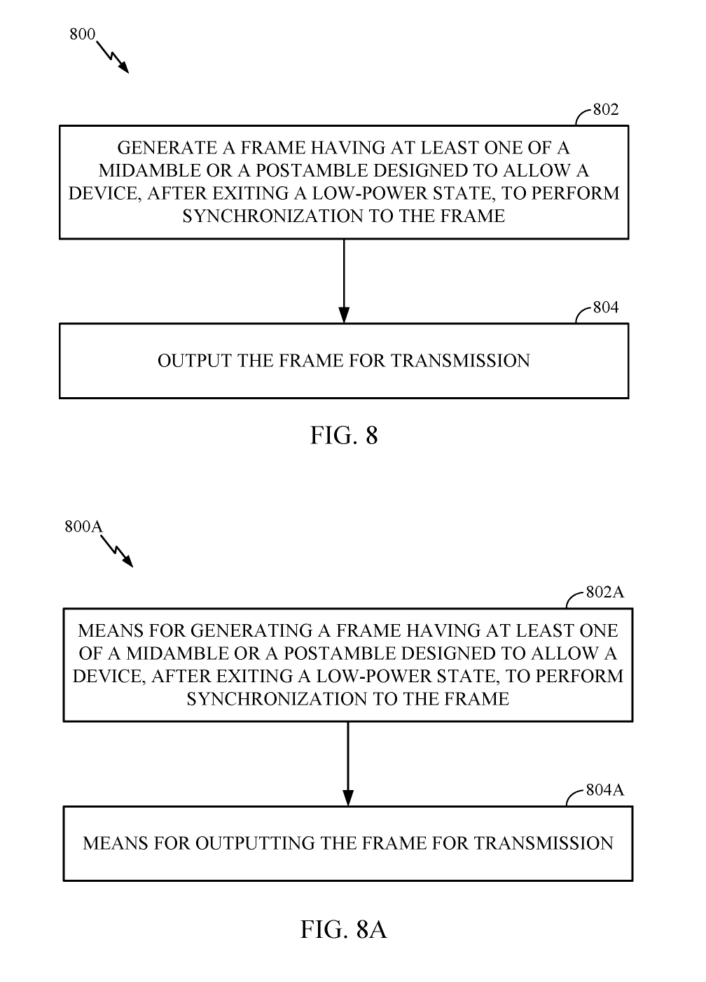

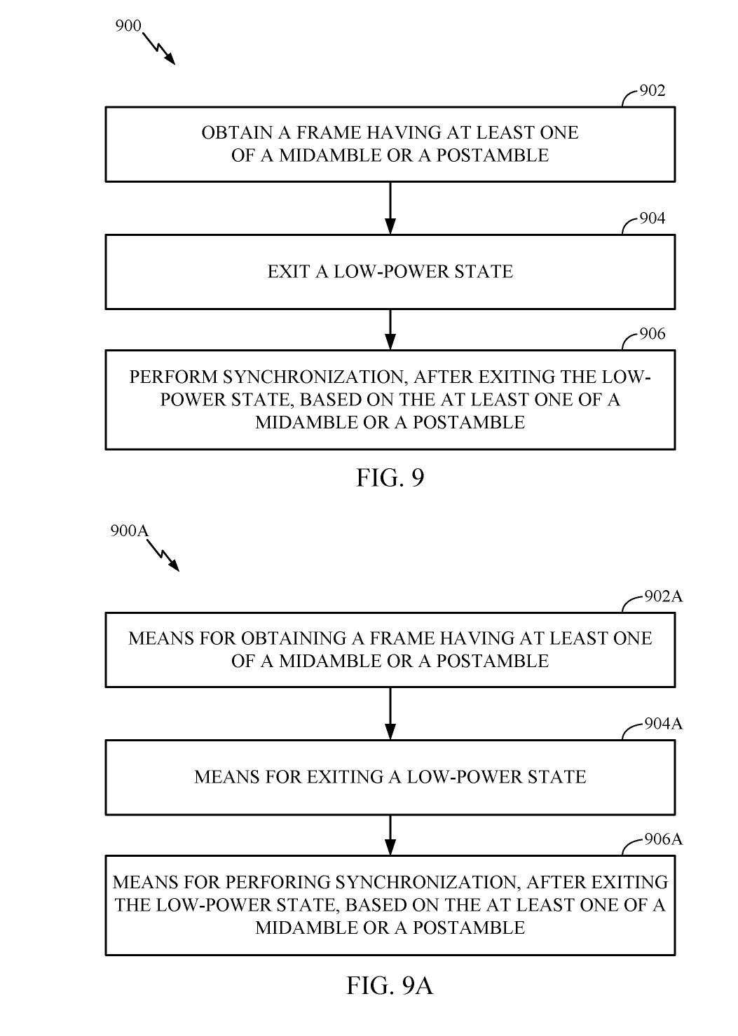

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 of the access point 110 may be used to perform the operations described herein and illustrated with reference to FIGS. 5 and 5A and FIGS. 8 and 8A. Similarly, antenna 252, Tx/Rx 254, processors 260, 270, 288, and 290, and/or controller 280 of the user terminal 120 may be used to perform the operations described herein and illustrated with reference to FIGS. 7 and 7A and FIGS. 9 and 9A.

FIG. 2 illustrates a block diagram of access point 110 two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,s} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

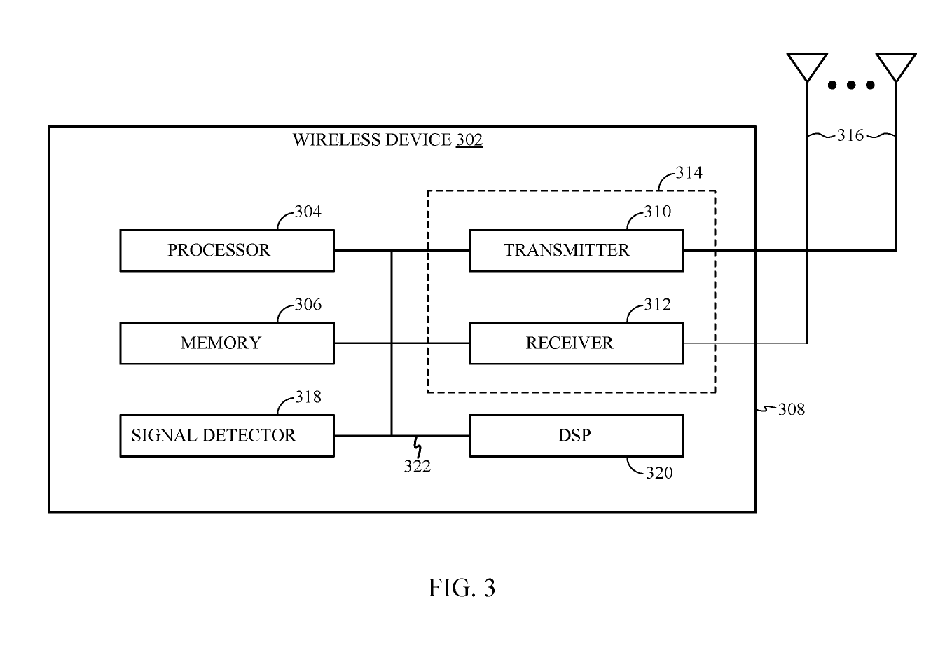

FIG. 3 illustrates various components that may be utilized in a wireless device 302 that may be employed within the MIMO system 100. The wireless device 302 is an example of a device that may be configured to implement the various methods described herein. For example, the wireless device may implement operations 500 and 700-900 illustrated in FIGS. 5 and 7-9, respectively. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Deferral Information in Postambles and Midambles

In shared mediums, deferral mechanisms are often used to try and avoid interference caused by colliding transmissions from different devices. As an example, a duration field in a preamble of a frame may provide an indication of how much time will be required for transmission of that frame. By detecting the preamble and reading the duration field, a device may set their network allocation vector (NAV), which is used to determine how long the device should defer from accessing the medium (e.g., to account for the frame and possibly an expected response to the frame, as well as possible subsequent transmissions). A device that fails to decode the preamble, for any reason, and does not have the duration information may not know how long it should defer accessing the medium.

Aspects of the present disclosure, however, provide mechanisms that may help a device determine a deferral period, even if it has missed a preamble. For example, according to certain aspects, deferral information may be provided in one or more later portions of a frame, such as a midamble or postamble. As used herein, the term midamble generally refers to any portion of a frame that occurs after a preamble, while the term postamble generally refers to a portion of a frame that occurs at the end of a frame (a postamble for a frame may even occur in a subsequent frame).

Aspects of the present disclosure may be applied in various wireless systems that rely on carrier sense mechanisms. For example, the techniques presented herein may be applied in certain systems, such as IEEE 802.11ax (also known as high efficiency wireless (HEW) or high efficiency wireless local area network (WLAN)), that use physical (PHY) layer and medium access control (MAC) layer signaling for requests and responses. As used herein, a response may refer to a response frame that is transmitted in response to a request frame.

A response may include an acknowledgment (ACK) frames, clear-to-send (CTS message) frames, etc. Lost responses may be undesirable. For example, a lost ACK may lead to re-transmission of successful packets which may reduce the transmitter's throughput and/or cause unnecessary interference. Having reliable responses is desirable, particularly, in the case of dense networks.

In one example of a device transmitting on top of (e.g., interfering with) a response, a Device A may be outside of a preamble range of a packet. Device A may begin a transmission during transmission of the original packet and Device A may continue transmission during the transmission of a response to the original packet.

In another example of a device transmitting on top of a response, Device A may be within the preamble range but may miss the preamble. Device A may receive no NAVsetting to protect an ACK sent in response to the original packet. Device A may transmit on top of the ACK regardless of its proximity to the original transmission. For example, even if Device A is within the energy detection (ED) range of the original packet, Device A may not be within the ED range of the ACK and, thus, may transmit over the ACK since arbitration interframe spacing (AIFS) does not guarantee deferral for all ACKs.

In yet another example of a device transmitting on top of a response, Device A may receive the preamble of the original packet, however, Device A may not receive the packet correctly. Device A may not receive a NAV setting to protect the ACK. In this case, Device A may rely on extended interface spacing (EIFS) to avoid transmitting on top of the ACK. EIFS may be equal to transmission time of a regular short ACK frame at the lowest physical layer (PHY) rate plus short interface space (SIFS) plus distributed interframe spacing (DIFS) (in some cases, EIFS may be longer). However, in certain systems with longer ACKs (e.g., 802.11ax systems), EIFS may not protect the longer ACKs, which may result in a collision (e.g., with one device transmitting “on top of a response from another device).

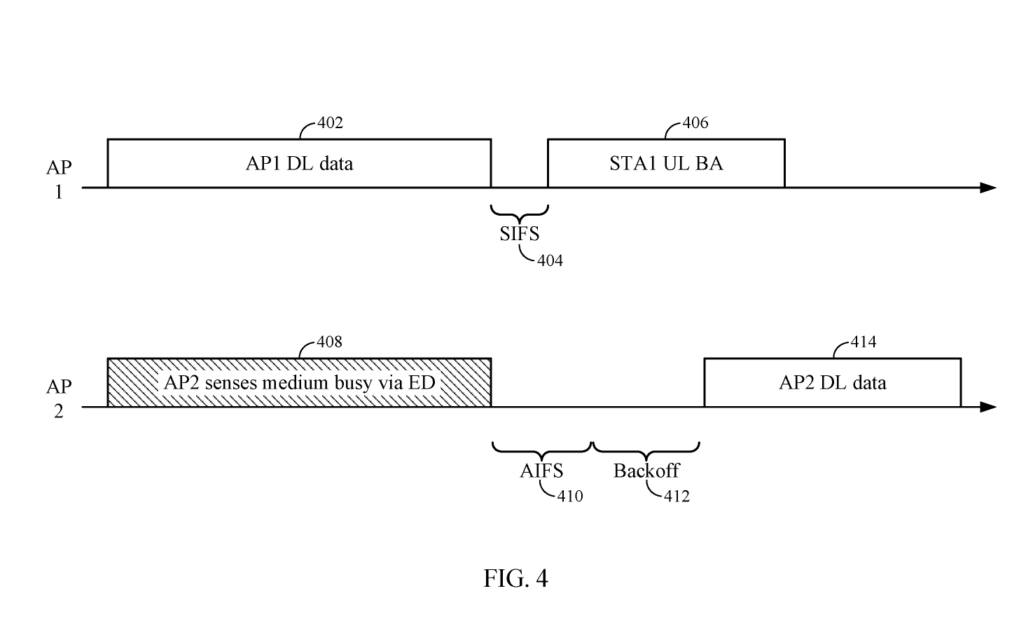

FIG. 4 illustrates an example of a device transmitting on top of a response. As shown in FIG. 4, a first device (AP1) may send DL data, at 402, to a second device (STA1). The STA1 may respond (e.g., after a SIFS period 404) with an UL block acknowledgment (BA) for the DL data at 406. In some cases, AP2 may be within ED range of the packet sent from AP1, but may not decode the preamble and NAV of the DL data packet transmitted by AP1. Thus, at 408, AP2 may only sense that the medium is busy, without reading duration information. Once AP1 finishes transmitting, AP2 may sense that the medium is idle and may begin transmitting its DL data, at 414, after an arbitration inter-frame spacing (AIFS) 410 (e.g., and possibly a random backoff period 412). If AP2 has an arbitration inter-frame spacing number (AIFSN) equal to three, then AIFS may be equal to SIFS plus AIFSN times the Slot_duration. In this case, AP2 may begin transmitting after 43 μs. In this case, the UL BA from STA1 may be jammed (interfered) by the transmission from AP2. If the BA has a payload of 36 bytes at modulation coding scheme (MCS) of zero, then the BA end time may be equal to SIFS plus legacy preamble duration plus the payload divided by the MCS rate which may be equal to 84 μs. Thus, since the BA is longer than the time before the AP2 begins transmitting, the BA will be jammed by the transmission from AP2.

As noted above, however, aspects of the present disclosure provide for use of midambles and postambles to improve reliability of responses by reducing the probability that other devices will transmit on top of (interfere) the responses.

According to certain aspects, deferral information may be included in midamble and/or a postamble in order to increase the probability that a detecting device will receive the information and defer.

FIG. 5 illustrates example operations 500, in accordance with certain aspects of the present disclosure. The operations 500 may be performed, for example, by a station (e.g., AP 110). The operations 500 may begin, at 502, by generating a first frame having at least one of a midamble or a postamble that provides an indication of a request for a device to defer transmitting for a duration. At 504, the AP may output the first frame for transmission. According to certain aspects, the duration is associated with a portion of the first frame and a response to the first frame to be transmitted. For example, the midamble and/or the postamble may indicate a request for the detecting device to defer long enough so that a response (e.g., a clear-to-send (CTS) message or an acknowledgment (ACK)) may be transmitted and received.

According to certain aspects, the midamble and/or postamble may convey 1 bit of information, indicating a request for the detecting device to defer. For example, the existence of a postamble may indicate a request for deferral for a set amount of time which may be prenegotiated (e.g., defined by the STA and the AP), fixed in the wireless standards, or fixed to a default value. A midamble may indicate that the requested deferral after the postamble is a set amount of time which may be prenegotiated, fixed in the wireless standards, or fixed to a default value.

Alternatively, the midamble and/or postamble may carry multiple (e.g., a plurality) bits. The multiple bits may indicate information such as basic service set (BSS) color (which may be used to assist the receiving device identify the BSS from which the frame originated), an indication of how long to defer after the end of the postamble (e.g., in units of time or as a mapping of certain bits to predefined durations), a duration until the end of the response, or a duration until the end of the packet (e.g., in units of time or as a mapping of certain bits to predefined durations), a type of response and modulation and coding scheme (MCS) for the response which the detecting device may use to determine for how long to defer, and/or any special deferral requests such as a request for overlapping basic service sets (overlapping BSSs, OBSSs) to defer.

According to certain aspects, different information may be included in the midamble than in the postamble. For example, midambles may carry information related to BSS color, while another midamble or a postamble may have deferral information, etc.

According to certain aspects, the postamble and/or the midamble may be a series (e.g., one or more) of short training fields (STFs). Detecting devices may use correlators to sense the STFs. For example, a device may sense the STFs in the same manner that it would sense a legacy STF. The presence of an STF without other preamble fields such as a long training field (LTF) or a signal field (SIG) may indicate a presence of the midamble and/or the postamble. As noted above, the midamble and/or postamble may convey 1 bit of information. Additional bits may be obtained based on the number of STFs or hidden in phase information of the STF.

Alternatively, the midamble and/or the postamble may be a series of STFs and LFTs. Absence of the SIG field may indicate presence of the midamble and/or the postamble.

In another alternative, the full preamble structure of STF, LTF, and SIG fields may be used and detecting devices may use correlators to find the preambles. For example, a detecting device may detect the STF, LTF, and SIG fields in the same manner that the detecting device would detect legacy STF, LTF, and SIG fields. A modified legacy preamble may be used with a legacy SIG field (LSIG) field to indicate the duration for the detecting device to defer. A specially defined SIG field may be used to indicate presence of the midamble and/or the postamble and the deferral information.

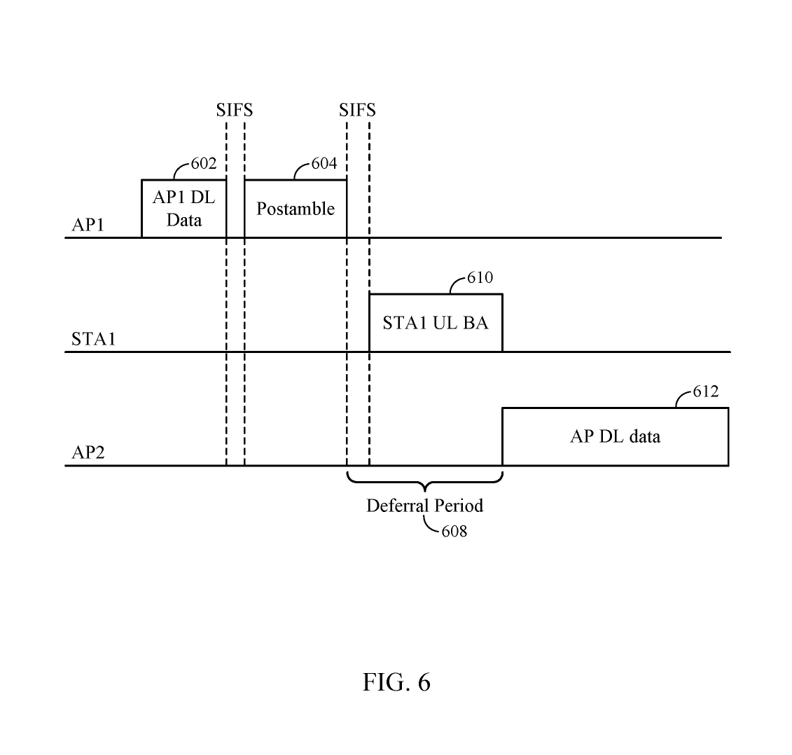

According to certain aspects, the postamble may be included in a separate frame than the packet with the preamble and/or midamble. The frame with the postamble may be included a frame that is transmitted a SIFS time after the end of the original packet as illustrated in FIG. 6. The frame with the postamble may provide protection for the response to the original packet. FIG. 6 is an example time sequence illustrating a postamble transmitted to protect a response, in accordance with certain aspects of the present disclosure. For example, similar to how a clear-to-send (CTS) frame functions to protect a request-to-send (RTS) frame.

A detecting (e.g., listening) device (e.g., a neighbor device of the transmitting device) may decode a midamble and/or a postamble even if it missed the preamble.

As shown in FIG. 6, API may send a packet 602 (e.g., API DL Data) to STA'. The packet may have a preamble and/or a midamble. After a SIFS time, AP1 may send a second frame 604 with the postamble. The postamble may include the same information as in the case where the postamble is included in the original packet (e.g., deferral information, and possible other information such as color ID, reliability request information, etc.). Thus, AP2 may detect the postamble and defer for the request duration 608, for example, the duration until the end of API's packet and a period indicated for the response. Thus, after another SIFS time, STA1 may send a protected ACK frame 610. AP2 may defer during the entire duration of the ACK 610, and refrain from sending AP DL data until after the ACK is sent. Thus, AP2 may transmit downlink data at 612.

FIG. 7 illustrates example operations 700, in accordance with certain aspects of the present disclosure. The operations 700 may be performed, for example, by a device (e.g., AP 110 or user terminal 120). The operations 700 may begin, at 702 by obtaining a frame having at least one of a midamble or a postamble that provides an indication of a request for a device to defer transmitting on a medium for a duration. At 704, the device may defer transmitting on the medium based on the duration. According to certain aspects, the device may sense one or more STFs, LTFs, and/or SIG fields in the midamble and/or preamble based on a correlation (e.g., as the device would sense a legacy STF, a legacy LTF, and/or a legacy SIG field). According to certain aspects, the device may determine presence of the midamble and/or the postamble based on absence of LTF and/or SIG fields in the frame. According to certain aspects, the device may determine information about the deferral duration based on a number of STFs in the frame or in phase information in the one or more STFs. According to certain aspects, a legacy SIG field may indicate the duration requested for deferral.

In one example implementation, if the detecting device misses the preamble and is within the energy detection (ED) range of the original packet, the device may sense the medium to determine whether the medium is still busy and could also check for midambles and/or postambles. Alternatively, if the detecting device misses the preamble and is not with ED range, but is within packet detection (PD) range of the original packet, the device may search the medium to determine whether the medium is idle and could check for midambles and/or postambles.

In another example implementation, the detecting device may decode the preamble of a packet but not decode the packet. If the preamble does not indicate the deferral time to the end of the response, the detecting device may rely on EIFS to protect the response. The detecting device may have some knowledge about the end of the packet. The detecting device may look for a postamble around the expected time of the end of the packet in order to, if a postamble is detected, obtain a better knowledge of how long to defer. According to certain aspects, the detecting device may pre-negotiate that a longer EIFS is to be used so that the detecting device may not transmit on top of a response. If the preamble is decoded, but the packet is dropped due to color, it may be useful for the device to search for a postamble.

According to certain aspects, postambles may be used in lieu of padding in the packet.

### Example Synchronization to Midamble and/or Postamble

According to certain aspects, midambles and/or postambles may also be used for synchronization. FIG. 8 illustrates example operations 800 for wireless communications, in accordance with certain aspects of the present disclosure. The operations 800 may be performed, for example, by a station (e.g., AP 110). The operations 800 may begin, at 802, by generating a frame having at least one of a midamble or a postamble designed to allow a device, after exiting a low-power state, to perform synchronization to the frame. At 804, the AP may output the frame for transmission. According to certain aspects, the generated frame may be an aggregated medium access control (MAC) protocol data unit (AMPDU) having an MPDU intended for the detecting device.

If multiple user (MU) AMPDUs are being sent on the downlink by the AP, the detecting device (e.g., a station (STA)) may receive its MPDU towards the beginning of the transmission, then the STA may go to sleep or enter a low-power state since the remainder of the MPDUs in the transmission are intended for other device, but the device may still wake up and/or exit the low-power state to send the ACK at a particular time. If the ACK is to be sent using MU multiple-input multiple-output (MIMO) or MU orthogonal frequency division multiple access (OFDMA), the start time of the ACK should be very precise. A postamble at the end of the packets from the AP may allow for the device to synchronize to allow for a precise ACK time.

As another example, a device, upon exiting a sleep mode or a low-power state may spend 6 ms in wait time before the device may access the medium. However, if the device detects a midamble and/or a postamble (which may be sooner than the 6 ms wait time), the device may be considered “synced” to the medium and may be able to transmit. By using the midamble and/or postamble for synchronization, the device may access the medium more quickly and without detecting the preamble.

FIG. 9 illustrates example operations 900 for wireless communications, in accordance with certain aspects of the present disclosure. The operations 900 may be performed, for example, by a detecting device (e.g., an STA). The operations 900 may begin, at 902, by obtaining a frame (e.g., a MU AMPDU) having at least one of a midamble or a postamble. At 904, the detecting device may exit a low-power state. At 906, the detecting device may perform synchronization, after exiting the low-power state, based on the at least one of a midamble or a postamble. According to certain aspects, the low-power state may be a sleep mode. According to certain aspects, the STA may process the AMPDU after performing synchronization. According to certain aspects, the STA may determine when to transmit a response to the frame based on the synchronization and may transmit the response in accordance with the determination .

The techniques described above for including midambles and postambles with deferral information may increase detection of requests for deferral by listening devices and allow for more reliable responses which may help reduce throughput losses and interference. Additionally, midambles and postambles may be used for synchronization and may enable quicker synchronization and access to the medium.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 and 700-900 illustrated in FIGS. 5 and 7-9, respectively, correspond to means 500A and 700A-900A illustrated in FIGS. 5A and 7A, respectively.

For example, means for obtaining and means for receiving may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting and means for outputting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for including, means for deferring, means for determining, means for performing, means for exiting, and means for sensing may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

According to certain aspects, such means may be implemented by processing systems configured to perform the corresponding functions by implementing various algorithms (e.g., in hardware or by executing software instructions) described above for providing an immediate response indication in a PHY header. For example, an algorithm for generating a first frame having at least one of a midamble or a postamble that provides an indication of a request for a device to defer transmitting for a duration and an algorithm for outputting the first frame for transmission. In another example, an algorithm for obtaining a frame having at least one of a midamble or a postamble that provides an indication of a request for a device to defer transmitting on a medium for a duration and an algorithm for deferring transmitting on the medium based on the duration. In yet another example, an algorithm for obtaining a frame having at least one of a midamble or a postamble and an algorithm for performing synchronization after exiting a low-power state, based on the at least one of a midamble or a postamble. In yet another example, an algorithm for generating a frame having at least one of a midamble or a postamble designed to allow a device, after exiting a low-power state, to perform synchronization to the frame and an algorithm for outputting the frame for transmission.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for generating a first frame having at least one of a midamble or a postamble that provides an indication of a request for a device to defer transmitting for a duration and instructions for outputting the first frame for transmission. In another example, instructions for obtaining a frame having at least one of a midamble or a postamble that provides an indication of a request for a device to defer transmitting on a medium for a duration and instructions for deferring transmitting on the medium based on the duration. In yet another example, instructions for obtaining a frame having at least one of a midamble or a postamble and instructions for performing synchronization, based on the at least one of a midamble or a postamble. In yet another example, instructions for generating a frame having at least one of a midamble or a postamble designed to allow a device to perform synchronization to the frame and instructions for outputting the frame for transmission.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to generate a first frame having at least one of a midamble or a postamble that provides an indication of a request for a device to defer transmitting for a duration; and
an interface configured to output the first frame for transmission.

2. The apparatus of claim 1, wherein the duration is associated with a portion of the first frame and a response to the first frame to be transmitted.

3. The apparatus of claim 2, wherein the response to the first frame comprises an acknowledgment (ACK) or a clear-to-send (CTS) message.

4. The apparatus of claim 1, wherein:
the at least one of the midamble or the postamble comprises a bit indicating the request for the device to defer, and
the duration is defined by the apparatus and the device, is defined in a standard, or is a default value.

5. The apparatus of claim 1, wherein:
the at least one of the midamble or the postamble comprises a plurality of bits indicating the request for the device to defer, and at least one of a basic service set (BSS) color, a duration of the remainder of the first frame, a duration for a response to the first frame to be transmitted, a type of the response, a modulation and coding scheme (MCS) of the response, or a request for overlapping BSSs (OBSSs) to defer.

6. The apparatus of claim 1, wherein:
the first frame has a midamble and a postamble, and
the processing system is configured to include different information in the midamble than in the postamble.

7. The apparatus of claim 1, wherein:
the at least one of a midamble or a postamble comprises one or more short training fields (STFs).

8. The apparatus of claim 1, wherein:
the at least one of a midamble or a postamble comprises one or more short training fields (STFs) and one or more long training fields (LTFs).

9. The apparatus of claim 1, wherein:
the at least one of a midamble or a postamble comprises one or more short training fields (STFs), one or more long training fields (LTFs), and one or more signal (SIG) fields.

10. The apparatus of claim 1, wherein:
the processing system is further configured to generate a second frame comprising the postamble, and
the interface is further configured to output the second frame for transmission to the device.

11. The apparatus of claim 10, wherein the interface is configured to output the second frame for transmission a short interframe space (SIFS) time after the first frame.

12. An apparatus for wireless communications, comprising:
an interface configured to obtain a frame having at least one of a midamble or a postamble that provides an indication of a request for a device to defer transmitting on a medium for a duration; and
a processing system configured to defer transmitting on the medium based on the duration.

13. The apparatus of claim 12, wherein:
the at least one of a midamble or a postamble comprises one or more short training fields (STFs), and
the processing system is configured to sense the one or more STFs based on as it would sense a legacy STF.

14. The apparatus of claim 13, wherein the processing system is configured to determine presence of the at least one of a midamble or a postamble based on absence of both long training fields (LTFs) and signal (SIG) fields.

15. The apparatus of claim 13, wherein the processing system is configured to determine information about the duration based on at least one of: a number of STFs in the frame or in phase information in the one or more STFs.

16. The apparatus of claim 12, wherein:
the at least one of a midamble or a postamble comprises one or more short training fields (STFs) and one or more long training fields (LTFs), and
the processing system is configured to determine presence of the at least one of a midamble or a postamble based on absence of a signal (SIG) field.

17. The apparatus of claim 12, wherein:
the at least one of a midamble or a postamble comprises one or more short training fields (STFs), one or more long training fields (LTFs), and one or more signal (SIG) fields, and
the processing system is configured to sense the one or more STFs, the one or more LTFs, and the one or more SIG fields as it would sense a legacy STF, a legacy LTF, and a legacy SIG.

18. The apparatus of claim 17, wherein the one or more SIG fields comprise at least a legacy SIG field that indicates the duration requested for deferral.

19. An apparatus for wireless communications, comprising:
an interface configured to obtain a frame having at least one of a midamble or a postamble; and
a processing system configured to exit a low-power state and perform synchronization, after exiting the low-power state, based on the at least one of a midamble or a postamble.

20. The apparatus of claim 19, wherein:
the obtained frame comprises a multiple user (MU) aggregated medium access control (MAC) protocol data unit (AMPDU) intended for the apparatus; and
the processing system is configured to process the AMPDU after performing the synchronization.

21. The apparatus of claim 19, wherein:
the processing system is configured to determine when to transmit a response to the frame based on the synchronization; and
the interface is further configured to output the response for transmission in accordance with the determination.

22. An apparatus for wireless communications, comprising:
a processing system configured to generate a frame having at least one of a midamble or a postamble designed to allow a device, after exiting a low-power state, to perform synchronization to the frame; and
an interface for outputting the frame for transmission.

23. The apparatus of claim 22, wherein the generated frame comprises a multiple user (MU) aggregated medium access control (MAC) protocol data unit (AMPDU) having an MPDU intended for the device.

24-77. (canceled)
